(19) United States
(12) Patent Application Publication
(10) Pub. No.: US 2006/0222337 A1
(43) Pub. Date: Oct. 5, 2006

(54) Digest reproducing apparatus and digest reproducing apparatus control method

(76) Inventors: Yoshifumi Fujikawa, Yokohama (JP); Yukio Fujii, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/368,669

(22) Filed: Mar. 7, 2006

(30) Foreign Application Priority Data
Mar. 30, 2005 (JP) 2005-099214

(51) Int. Cl. H04N 7/00

(52) U.S. Cl. 386/95

(57) ABSTRACT

A digest reproducing apparatus which creates and shows a digest which gives an overview of a whole motion video content regardless of the number of scenes included in an original content. To achieve the above technique, for example, we need to record data on plural still images obtained by encoding plural consecutive still images in time order, detect a scene change in a motion video obtained by reproducing the still image data in time order, calculate an index value indicating the significance level of each still image in the motion video from the still image data, rank scenes in the motion video based on index values indicating the significance levels of still images, and reproduces digest still images included in a specified number of scenes selected according to the ranking.

### CLAIM OF PRIORITY

The present application claims priority from Japanese application Serial No. JP 2005-099214, filed on Mar. 30, 2005, the content of which is hereby incorporated by reference into this application.

### BACKGROUND OF THE INVENTION

The present invention relates to a digest reproducing apparatus which creates a digest of a motion video content and a method of controlling a digest reproducing apparatus.

Recently, TV receivers with a built-in hard disk which can perform recording for many hours and video browsing devices which enable users to browse motion video contents distributed through a communication network have been spreading. Therefore, the volume of motion video contents which viewers handle is rapidly increasing.

However, time available for viewers is too limited to see all large volumes of motion video contents. Against this background, there is need for a technique which enables viewers to see motion video contents efficiently.

In order to meet this need, various techniques which help viewers roughly grasp motion video contents in a short time by playing summaries of the motion video contents or simultaneously showing thumbnails of various scenes or shots in the motion video contents have been developed (for example, Japanese Patent No. 3367268 and Japanese Patent Laid-Open Publication No. 2004-312567).

### SUMMARY OF THE INVENTION

In creating a digest of a motion video content, images which are thought to be significant in the motion video content are selected. However, if images only in limited scenes should be selected for a digest, viewers who see the digest might be unable to get an overview of the motion video content.

On the other hand, if a digest is created by picking up images at regular intervals of time or images, a less significant part of the content might be reproduced for a relatively long time or a significant part might be partially lost in the digest.

The present invention has been made in view of the above problem and its primary object is to provide a digest reproducing apparatus which creates, regardless of the number of scenes in an original motion video content, a digest which gives an overview of the whole motion video content and a method of controlling such a digest reproducing apparatus.

In order to solve the above problem, the present invention relates to a digest reproducing apparatus which includes: a data recording part that records, as motion video data, data on plural still images obtained by encoding plural consecutive still images in time order; a scene change detecting part that detects a scene change in a motion video obtained by reproducing the still image data in time order, based on the still image data; a significance level calculating part that calculates an index value indicating the significance level of each still image in the motion video from the still image data; a scene ranking part that ranks scenes in the motion video based on index values indicating the significance levels of still images included in each scene of the motion video; and a digest reproducing part that reproduces as a digest, in time order, still images included in a specified number of scenes selected according to the ranking.

Other problems disclosed by the present invention and solutions to them will be apparent from the following detailed description of a most preferred embodiment and the accompanying drawings.

According to the present invention, it is possible to provide a digest reproducing apparatus which creates, regardless of the number of scenes in an original motion video content, a digest which gives an overview of the whole motion video content and a method of controlling such a digest reproducing apparatus.

### BRIEF DESCRIPTION OF THE DRAWINGS

FIG. 1 is a block diagram showing the general structure of a digest reproducing apparatus according to an embodiment of the present invention;

FIG. 2 is a memory unit of a digest reproducing apparatus according to the embodiment;

FIG. 3 is a diagram showing motion video data according to the embodiment;

FIG. 4 is a frame significance level control table according to the embodiment;

FIG. 5 is a constant vector definition table according to the embodiment;

FIG. 6 is a flowchart showing the process of calculating the significance level of a frame according to the embodiment;

FIG. 7 is a flowchart showing the process of creating and reproducing a digest according to the embodiment;

FIG. 8 is a flowchart showing the process of creating and reproducing a digest according to the embodiment;

FIG. 9 is a flowchart showing the process of creating and reproducing a digest according to the embodiment; and

FIG. 10 shows a formula for calculating the significance level according to the embodiment.

### DETAILED DESCRIPTION OF THE PREFERRED EMBODIMENT

Example of the General Structure

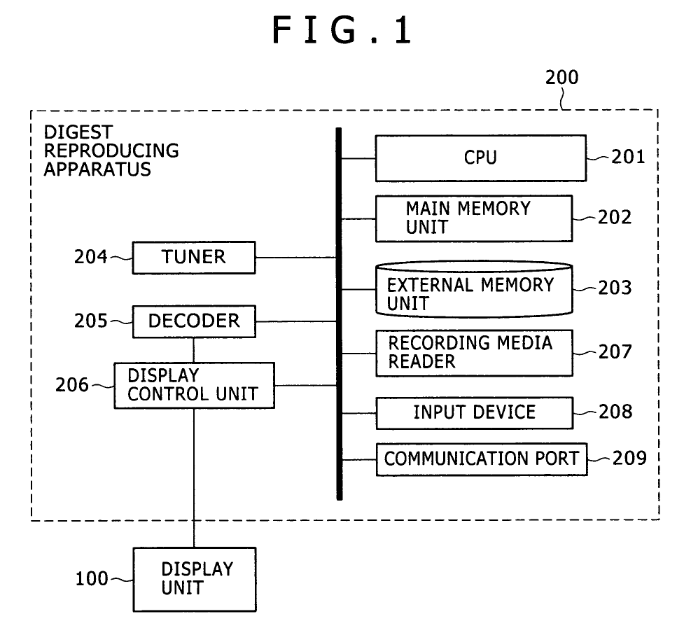

FIG. 1 shows the general structure of a digest reproducing apparatus 200 according to the preferred embodiment of the present invention.

The digest reproducing apparatus 200 includes a tuner 204, a decoder 205, a display control unit 206, a central processing unit 201, a main memory unit 202, an external memory unit 203, a recording media reader 207, an input device 208, and a communication port 209. The digest reproducing apparatus 200 is connected with a display unit 100 through the display control unit 206.

The central processing unit 201 is responsible for control of the whole digest reproducing apparatus 200. A digest reproducing apparatus control program 900 stored in the external memory unit 203 is read into the main memory unit 202, where the program is made up of codes for various operations according to this embodiment, and various functions of the digest reproducing apparatus 200 are performed by execution of the program. For example, when the central processing unit 201 executes the digest reproducing apparatus control program 900 and works in conjunction with hardware devices such as the tuner 204, decoder 205, display control unit 206, main memory unit 202, external memory unit 203, recording media reader 207, input device 208 and communication port 209, the functions of a data recording part, a scene change detecting part, a significance level calculating part, a scene ranking part, a digest reproducing part, a digest scene number input part, a digest reproducing time input part, a broadcast data receiving part and a communication data receiving part are preformed.

The tuner 204 is a device which receives broadcast sound and image data as motion video data. For example, it may be designed to receive different types of broadcasting signals including digital satellite broadcasting, digital ground wave broadcasting, and digital CATV (Community Antenna Television system or Cable Television) signals. It may also be a device designed to receive analog broadcasting signals.

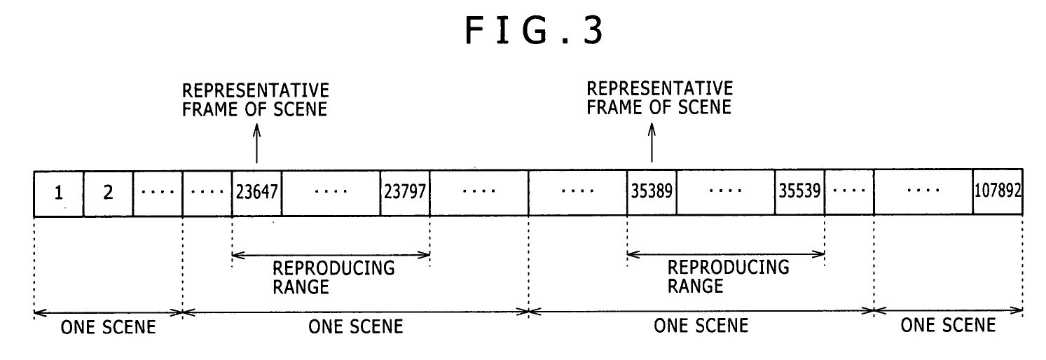

Motion video data includes data on plural still images obtained by encoding plural consecutive still images in time order. Each still image is sometimes called a frame. FIG. 3 shows an example of motion video data according to this embodiment. As shown in FIG. 3, motion video data is made up of data on plural still images. Each still image (data) has a frame number which represents the order of the still image in terms of time. In the example of FIG. 3, still images (data) are given frame numbers 1 to 107892. Motion video can be restored by reproducing still image data in time order (namely in the frame number order). Usually a motion video includes plural scenes or shots (a series of images taken for a movie, etc. from when the camera starts rolling until it stops). The motion video shown in FIG. 3 includes four scenes. The most significant still image in each scene is called a representative frame of the scene, which will be later explained in detail. In the example of FIG. 3, the frames numbered 23647 and 35389 are representative frames of the second scene and the third scene, respectively.

On the other hand, still image data includes data which indicates the color of each of pixels constituting each still image. For example, two bits for each of R (red), G (green) and B (blue) are used for each pixel. In this case, the color of each pixel may be one of 64 colors. In addition, still image data include sound data.

Going back to FIG. 1, the decoder 205 decodes motion video data and sends the decoded motion video data to the display control unit 206.

The display control unit 206 outputs the decoded motion video data to the display unit 100.

The display unit 100 displays the motion video. The display unit 100 has, for example, a display and a speaker.

The main memory unit 202 is used as a work area by the central processing unit 201 or stores the digest reproducing apparatus control program 900. For example, it may be a RAM (random access memory).

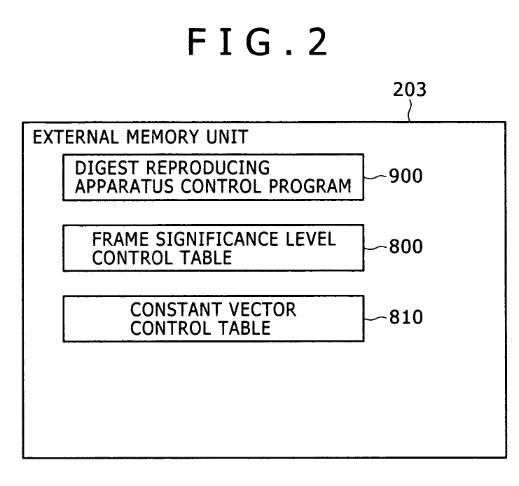

The external memory unit 203 may be, for example, a hard disk drive. The external memory unit 203 stores the digest reproducing apparatus control program 900, frame significance level control table 800, and constant vector control table 810, as shown in FIG. 2.

The digest reproducing apparatus control program 900 is a program which enables the digest reproducing apparatus 200 to function. For example, it calculates a feature vector (described later) for each of still images which constitute a motion video and detects scene changes included in a motion video, on a basis of still images, which will be later described in detail.

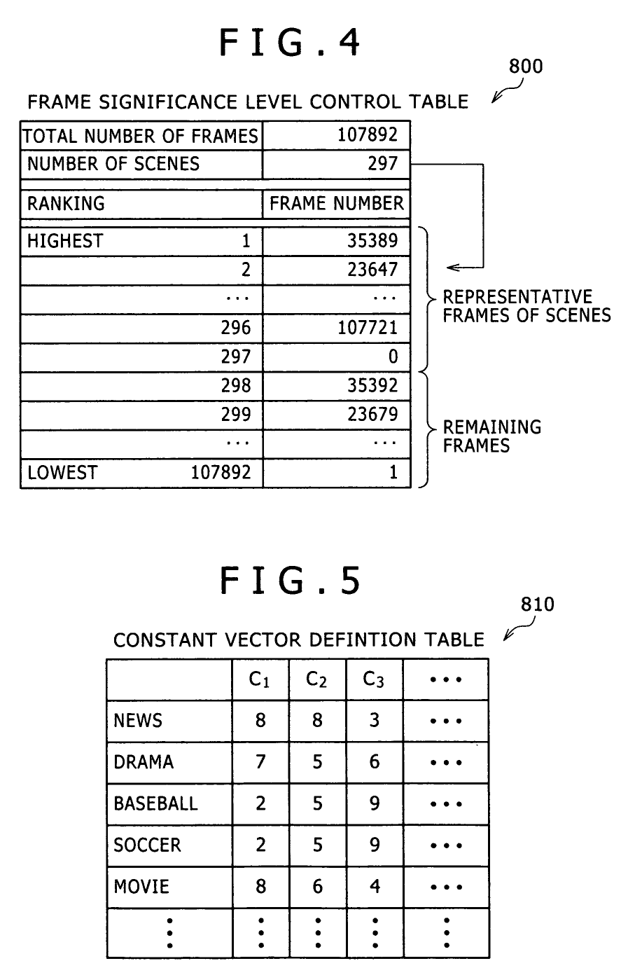

The frame significance level control table 800 is a table which is intended to control the significance level of each still image in a motion video. The frame significance level control table 800 is shown in FIG. 4. As shown in FIG. 4, in the frame significance level control table 800 according to this embodiment, still images are ranked in the descending order of significance and stored. In addition, the frame significance level control table 800 shown in FIG. 4 shows ranking by significance of still images in a motion video containing 297 scenes in total and the upper 297 still images in the ranking are images whose significance is the highest in each scene. These still images, namely still images which are most significant in each scene (representative frames), are ranked Number 1 to Number 297 in the descending order of significance. This also means that the scenes included in the motion video are ranked from Number 1 to No. 297 in terms of significance. In other words, the scene containing the frame numbered 35389, which is ranked first, is thought to be the most significant scene in the motion video. On the other hand, the scene containing the frame numbered 0, which is ranked 297th, is thought to be the least significant scene in the motion video. The frames in the 298th to 107892nd places in the ranking are frames which are simply ranked by significance regardless of the scenes which they belong to. As an alternative approach, a frame number in the frame significance level control table 800 may be replaced by something that indicates a position in the content. For instance, it may be something (in bytes) that indicates the location of data constituting a frame or PTS (Presentation Time Stamp) which indicates time to display.

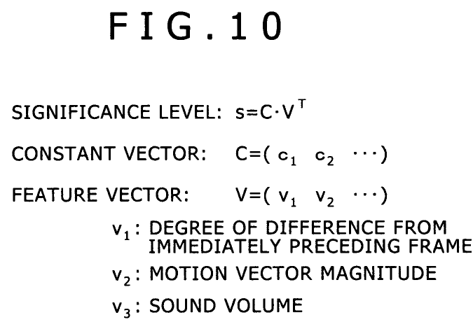

FIG. 10 shows a formula for calculating an index value which represents the significance level of each still image. As shown in FIG. 10, according to this embodiment, the significance level of each still image is determined by the inner product of a constant vector and a feature vector. Constant vector data is stored in a constant vector control table 810 according to the motion video categorization as shown in FIG. 5. The feature vector is a vector which is composed of the following elements: index values which respectively indicate the degree of difference from the immediately preceding frame (still image just before the current one in terms of time), motion vector magnitude, and sound volume in reproducing of still image data.

Then, the index value which indicates the significance level of each frame is determined by calculating the inner product of a feature vector determined for each still image and a constant vector defined in FIG. 5.

The degree of difference from the immediately preceding frame may be considered to be the degree of difference between the color distribution data of the current frame and that of the immediately preceding frame. Here, color distribution data refers to the frequency of appearance of pixels which represent a color, within an entire frame. For example, when generating color distribution data for 64 colors where R, G and B are each to be expressed by two bits, the number of pixels representing each of 64 colors is counted where pixels of a frame are reduced to 64 colors with each color being expressed by six bits, namely top two bits of each of R, G and B values. In this case, color distribution data is expressed by Hn(i) where i is a number between 0 and 63. If i is 0, Hn(0) denotes the number in a frame of pixels that have zeros for all top two bits of each of R, G and B values. The degree of difference of Hn from Hn−1, namely the color distribution data of the immediately preceding frame, is calculated in accordance with a chi-square formula.

Going back to FIG. 1, the recording media reader 207 is a device which is designed to read motion video data recorded on a video tape, a DVD (Digital Versatile Disk) or the like. The motion video data thus read is stored in the external memory unit 203 and the main memory unit 202.

The input device 208 is a device which is used for data input to the digest reproducing apparatus 200 or a similar purpose and functions as a user interface. For example, a control switch, touch panel, remote controller, keyboard, mouse or the like may be used as the input device 208.

The communication port 209 is a device which is used for communication with another data processing device such as a computer or another digest reproducing apparatus 200. For example, arrangements can be made so that various types of motion video data which is sent from a motion video distribution server connected through the Internet in a communicable manner can be received through the communication port 209. In this case, the received motion video data is stored in the external memory unit and main memory unit 202.

Flow of Processing with the Digest Reproducing Apparatus

Next, the process of creating, from a motion video, a digest as a summary of the motion video using the digest reproducing apparatus 200 according to this embodiment and reproducing it will be explained.

<Calculation of the Level of Significance of a Frame>

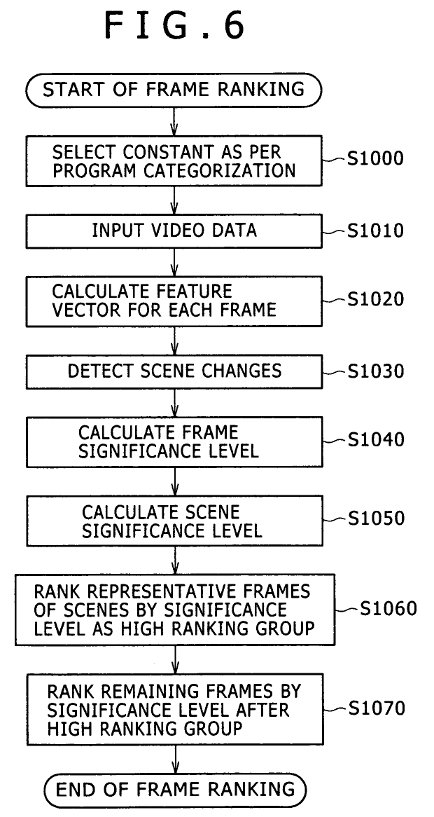

The digest reproducing apparatus 200 according to this embodiment calculates the significance level of each still image included in a motion video in accordance with the abovementioned formula and generates the frame significance level control table 800 as shown in FIG. 4. This process is shown in the flowchart of FIG. 6.

First, the digest reproducing apparatus 200 according to this embodiment selects a constant vector (S1000). Constant vector selection is made by choosing an appropriate value from the constant vector control table 810 according to the motion video content categorization (sport, drama, news, etc) as shown in FIG. 5. The category information can be obtained, for example, from an EPG (Electronic Program Guide). It is needless to say that the user can enter constant data through the input device 208.

The digest reproducing apparatus 200 reads video content data (motion video data) (S1010). Reading of video content data can be performed by receiving broadcast motion video data using the tuner 204 or by receiving motion video data sent from a data processing unit connected through the communication port 209 in a communicable manner. It can also be performed by reading motion video data recorded in a recording medium such as a DVD or video tape through the recording media reader 207.

Then, the digest reproducing apparatus 200 calculates a feature vector for each frame in the video content data read at step S1010. The elements of a feature vector include the degree of difference from the immediately preceding frame, motion vector magnitude and sound volume.

After that, using the degree of difference from the immediately preceding frame as calculated at step S1020, the digest reproducing apparatus 200 detects scene changes (points of transition from one scene to another) (S1030). A scene change can be detected according to the result of comparison of the degree of difference between the above color distribution data Hn and color distribution data Hn−1 for the immediately preceding frame with a reference value. If the degree of difference is beyond the reference value, it is decided that it is a scene change. Frames between one scene change and a next one constitute one scene.

Next, the digest reproducing apparatus 200 calculates the significance level of each frame (S1040). The significance level is determined by calculating the inner product of a feature vector and a constant vector as shown in FIG. 10. Alternatively, the method as described in JP-A No. 2004-312567 may be used.

Then, the digest reproducing apparatus 200 calculates the significance level of each of scenes into which the motion video has been divided at step S1030. The significance level of a scene may be represented by the highest frame significance level within the scene. The frame whose significance level is the highest in a scene is chosen as the representative frame of the scene. However, it is also possible to use the average significance level for the frames in each scene as the significance level of the scene. Also, the length (time duration) of the scene and the highest significance level in the scene may be combined in the calculation. As the representative frame of a scene, the top frame or temporally central frame in the scene may be chosen.

Next, the digest reproducing apparatus 200 ranks representative frames of various scenes in the descending order of scene significance level where the representative frames are in a high ranking frame group. The ranking result is stored in the frame significance level control table 800 shown in FIG. 4 (S1060).

Then, the digest reproducing apparatus 200 ranks remaining frames, or frames other than representative frames of the scenes, in the descending order of frame significance level where these frames are in a low ranking frame group. The result is stored in the frame significance level control table 800 shown in FIG. 4 (S1070).

<Creation of a Digest and Playback>

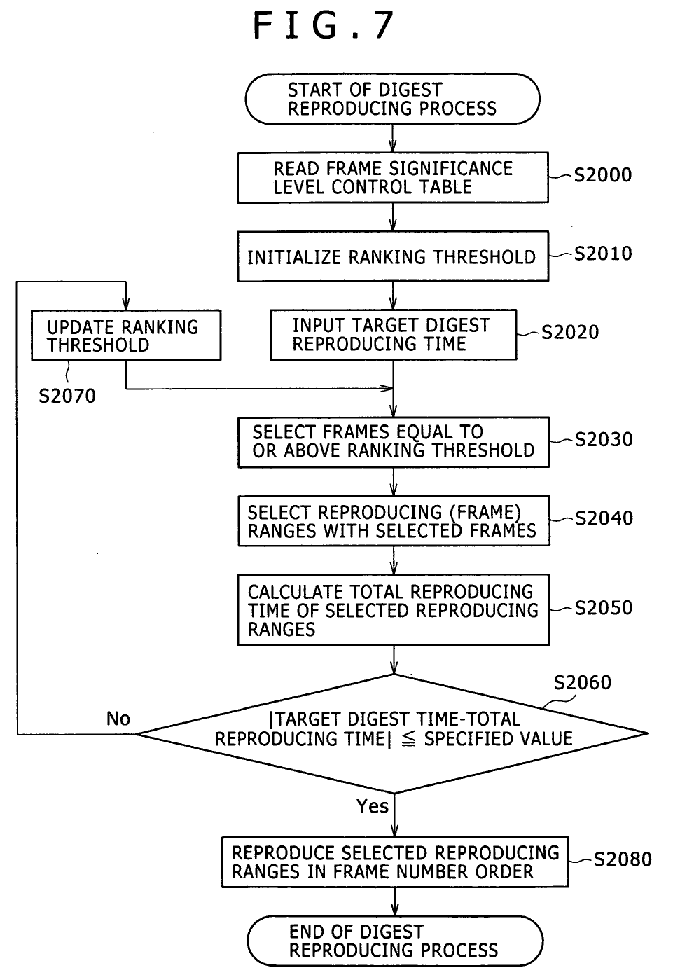

Next, the digest reproducing apparatus 200 according to the present invention creates a digest as a summary of a motion video (video content) based on the frame significance level control table 800 and reproduces it. This process is shown in the flowchart of FIG. 7.

The digest reproducing apparatus 200 reads ranking data for frames from the frame significance level control table 800 (S2000). Next, the digest reproducing apparatus 200 initializes a ranking threshold (a specified number) (S2010). The ranking threshold indicates the number of scenes to be reproduced in a digest. The initial value for the ranking threshold may be preset, for example, to 5. Instead, the viewer, etc. may enter an initial value for the threshold using the input device 208. Then, the digest reproducing apparatus 200 receives input of digest reproducing time (time duration which will be used to reproduce the digest) which the viewer requests (S2020). Let's say that it is 2 minutes.

Then, the digest reproducing apparatus 200 first selects frames ranked higher than the ranking threshold from among ranked frames in the frame significance level control table 800 (S2030). Then, the digest reproducing apparatus 200 determines a reproducing range, or a range of frames to be reproduced, on the basis of the selected frames (S2040). For example, a reproducing range is determined so as to cover frames within a given time after a selected frame where the selected frame is the top frame in the range. This time may be determined by dividing the digest reproducing time by the above ranking threshold number. Needless to say, another approach may be used to determine the time.

Next, the digest reproducing apparatus 200 calculates total time required to reproduce all the reproducing ranges which begin from selected frames (S2050). Then the digest reproducing apparatus 200 compares the calculated total time with the digest reproducing time requested by the viewer (S2060). When the difference between the calculated total time and the requested digest reproducing time is smaller than a prescribed value, the process goes to “Yes”. If the difference is not smaller than the prescribed value, the process goes to “No.” If time to reproduce a whole scene is relatively short, it may be shorter than the time calculated by dividing the requested digest reproducing time by the ranking threshold number. If there is such a scene, the difference between the calculated total time and the digest reproducing time requested by the viewer may not be smaller than a prescribed value. In that case, the process goes to step S2070 to change the ranking threshold. For example, the current ranking threshold is changed to a larger number. If so, the steps from S2030 are repeated again. It is also possible to arrange that the ranking threshold is updated at step S2070 according to the result of comparison made at step S2060. For example, if the time calculated at step S2050 is longer than the digest reproducing time requested by the viewer, the ranking threshold may be changed to a higher ranking (a smaller number). Contrariwise, if the time calculated at step S2050 is shorter than the digest reproducing time requested by the viewer, the ranking threshold may be changed to a lower ranking (a larger number). The scale of change can be expressed using known algorithm such as binary search.

After the process goes to “Yes” at step S2060, the digest reproducing apparatus 200 reproduces the reproducing ranges which begin from the above selected frames, in time order (S2080).

As the digest reproducing apparatus 200 according to this embodiment carries out the above steps, the viewer can see the summarized content which takes the length of time specified by the viewer (2 minutes in this example). The digest thus created contains images extracted from significant scenes where the extracted images from each scene correspond to a specified time duration. In other words, the viewer can see a digest which gives an overview of a motion video content, regardless of the number of scenes in the original motion video.

As can be understood from the above, in the digest reproducing apparatus 200 according to this embodiment, for example, if a motion video is made up of two scenes and 1 is specified for the number of scenes to be reproduced in a digest, its digest will be made up of images extracted from one of the two scenes, which correspond to a specified time duration.

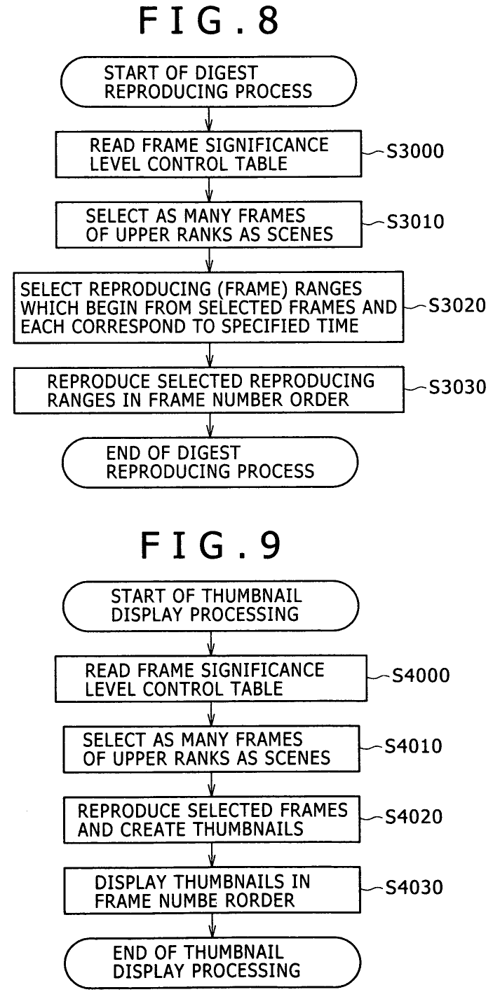

In addition, the digest reproducing apparatus 200 according to this embodiment can also create a digest so that every scene is reproduced for specified time, as indicated in the flowchart in FIG. 8. For example, when the viewer edits a video which he or she has recorded, he or she may want to know what kinds of images each scene includes. In this case, such a digest is particularly convenient.

First, the digest reproducing apparatus 200 according to this embodiment reads information on the ranking of frames from the frame significance level control table 800 (S3000). Then, as many frames of upper ranks as scenes are selected from the frame significance level control table 800 (S3010). In other words, representative frames of all scenes are selected. Then, the digest reproducing apparatus 200 determines a reproducing range based on each of the above selected frames, where the range should correspond to a specified time duration (S3020). For example, a range of frames from a selected frame which corresponds to two seconds is selected as a reproducing range. Then, the digest reproducing apparatus 200 reproduces the reproducing ranges which each begin from the above selected frames, in time order (3030).

As just described, the digest reproducing apparatus 200 according to this embodiment can create a digest so that every scene is reproduced for specified time.

Furthermore, the digest reproducing apparatus 200 according to this embodiment can also create thumbnails of all scenes and display them. When the viewer edits a video which he or she has recorded, this function is particularly convenient if he or she wants to know what kinds of images each scene includes.

First, the digest reproducing apparatus 200 reads information on the ranking of frames from the frame significance level control table 800 (S4000). Then, as many frames of upper ranks as scenes are selected from the frame significance level control table 800 (S4010). In other words, representative frames of all scenes are selected. Then, the digest reproducing apparatus 200 creates thumbnails of the above selected frames (S4020). Then, the digest reproducing apparatus 200 displays the above created thumbnails in frame number order (S4030).

As described, the digest reproducing apparatus 200 according to this embodiment can also create thumbnails of all scenes.

In the digest reproducing apparatus 200 according to this embodiment which has been so far explained, it is possible to create a digest which enables the viewer to get an overview of the whole content within a time duration specified by the viewer.

In addition, if arrangements are made so that ranking information generated by the digest reproducing apparatus 200 according to this embodiment is distributed to viewers through a network or broadcasting, viewers who have a video reproducing apparatus capable of receiving ranking information through a network or broadcasting without generating ranking information in the video reproducing apparatus can obtain a digest which gives an overview of a whole video content.

While the most preferred embodiment of the present invention has been explained so far, it is understood that the above embodiment is illustrative for the purpose of facilitating the understanding of the present invention and not restrictive in terms of interpretation thereof. It is obvious that the present invention may be embodied in any modified or varied form without departing the spirit and scope thereof and also includes its equivalents. For example, the digest reproducing apparatus 200 according to this embodiment may be an HDD recorder, a DVD recorder, a set-top box, a TV receiver, a radio receiver, a mobile phone, a portable memory device, a personal computer or the like.

What is claimed is:

1. A digest reproducing apparatus comprising:
a data recording part that records data, as motion video data, on a plurality of still images obtained by encoding a plurality of consecutive still images in time order;
a scene change detecting part that detects a scene change in a motion video obtained by reproducing the still image data in time order, based on the still image data;
a significance level calculating part that calculates an index value indicating the significance level of each still image in the motion video from the still image data;
a scene ranking part that ranks scenes in the motion video based on index values indicating the significance levels of still images included in each scene of the motion video; and
a digest reproducing part that reproduces as a digest, in time order, still images included in a specified number of scenes selected according to the ranking.

2. The digest reproducing apparatus according to claim 1, wherein the scene change detecting part:
calculates, for each still image, color distribution data indicating the number of pixels representing each color, based on data indicating colors of pixels constituting each still image, which is included in the still image data;
calculates an index value indicating the degree of difference of color distribution data on each still image from color distribution data on the immediately preceding still image in terms of time; and
detects a scene change based on a result of comparison of the index value with a reference value.

3. The digest reproducing apparatus according to claim 1, wherein the importance level calculating part:
calculates, for each still image, color distribution data indicating the number of pixels representing each color, based on data indicating colors of pixels constituting each still image, which is included in the still image data;
calculates an index value indicating the degree of difference of color distribution data on each still image from color distribution data on the immediately preceding still image in terms of time;
calculates an index value indicating a sound volume in reproducing of each still image, based on sound data included in the still image data; and
calculates an index value indicating the significance level of each of the still images, based on the index value for the degree of difference and the index value for the sound volume.

4. The digest reproducing apparatus according to claim 1, wherein the scene ranking part ranks the various scenes in the descending order of highest index values in the various scenes, each index value indicating the significance level of a still image in a scene.

5. The digest reproducing apparatus according to claim 1, further comprising a digest scene number input part that receives information on the specified number of scenes to be reproduced in the digest, which is entered through a user interface.

6. The digest reproducing apparatus according to claim 5, further comprising a digest reproducing time input part that receives information on reproducing time of the digest which is entered through a user interface, wherein:
the digest reproducing part reproduces still images included in the specified number of scenes selected according to the ranking, in time order as a digest in which the reproducing time of each scene corresponds to a time duration obtained by dividing the digest reproducing time by the specified number.

7. The digest reproducing apparatus according to claim 6, wherein the digest reproducing part reproduces still images included in the specified number of scenes selected according to the ranking, in time order as a digest in which each scene begins from a still image with the highest significance level index value in the scene and the reproducing time of each scene corresponds to a time duration obtained by dividing the digest reproducing time by the specified number.

8. The digest reproducing apparatus according to claim 1, further comprising a broadcast data receiving part that receives broadcast sound and image data as the motion video data.

9. The digest reproducing apparatus according to claim 1, further comprising a communication data receiving part that receives, as the motion video data, sound and image data which is sent from a data processing unit connected in a communicable manner.

10. A method of controlling a digest reproducing apparatus which records, as motion video data, data on a plurality of still images obtained by encoding a plurality of consecutive still images in time order, wherein the digest reproducing apparatus:
detects a scene change in a motion video obtained by reproducing the still image data in time order, based on the still image data;
calculates an index value indicating the significance level of each still image in the motion video from the still image data;
ranks scenes in the motion video based on index values indicating the significance levels of still images included in each scene of the motion video; and
reproduces as a digest, in time order, still images included in a specified number of scenes selected according to the ranking.

11. The digest reproducing apparatus control method according to claim 10, wherein the digest reproducing apparatus:
calculates, for each still image, color distribution data indicating the number of pixels representing each color, based on data indicating colors of pixels constituting each still image, which is included in the still image data;
calculates an index value indicating the degree of difference of color distribution data on each still image from color distribution data on the immediately preceding still image in terms of time; and
detects a scene change based on a result of comparison of the index value with a reference value.

12. The digest reproducing apparatus control method according to claim 10, wherein the digest reproducing apparatus:
calculates, for each still image, color distribution data indicating the number of pixels representing each color, based on data indicating colors of pixels constituting each still image, which is included in the still image data;
calculates an index value indicating the degree of difference of color distribution data on each still image from color distribution data on the immediately preceding still image in terms of time;
calculates an index value indicating a sound volume in reproducing of each still image, based on sound data included in the still image data; and
calculates an index value indicating the significance level of each of the still images, based on the index value for the degree of difference and the index value for the sound volume.

13. The digest reproducing apparatus control method according to claim 10, wherein the digest reproducing apparatus ranks the various scenes in the descending order of highest index values in the various scenes, each index value indicating the significance level of a still image in a scene.

14. The digest reproducing apparatus control method according to claim 10, wherein the digest reproducing apparatus receives information on the specified number of scenes to be reproduced in the digest, which is entered through a user interface.

15. The digest reproducing apparatus control method according to claim 14, wherein the digest reproducing apparatus:
receives information on reproducing time of the digest which is entered through a user interface; and
reproduces still images included in the specified number of scenes selected according to the ranking, in time order as a digest in which the reproducing time of each scene corresponds to a time duration obtained by dividing the digest reproducing time by the specified number.

16. The digest reproducing apparatus control method according to claim 15, wherein the digest reproducing apparatus reproduces still images included in the specified number of scenes selected according to the ranking, in time order as a digest in which each scene begins from a still image with the highest significance level index value in the scene and reproducing time of each scene corresponds to a time duration obtained by dividing the digest reproducing time by the specified number.

17. The digest reproducing apparatus control method according to claim 10, wherein the digest reproducing apparatus receives broadcast sound and image data as the motion video data.

18. The digest reproducing apparatus control method according to claim 10, wherein the digest reproducing apparatus receives, as the motion video data, sound and image data which is sent from a data processing unit connected in a communicable manner.

19. A method of controlling a digest reproducing apparatus which records, as motion video data, data on a plurality of still images obtained by encoding a plurality of consecutive still images in time order, the motion video made up of two scenes, wherein:
when the digest reproducing apparatus receives 1 as the number of scenes to be reproduced in a digest as a summary of the motion video, from a user interface, the digest reproducing apparatus reproduces still images included in one of the two scenes in time order as a digest.
